(19) United States
(12) Patent Application Publication
(10) Pub. No.: US 2012/0193338 A1
(43) Pub. Date: Aug. 2, 2012

(54) APPARATUS FOR REMOVING ICE AND SNOW FROM THE ROOF OF A VEHICLE

(76) Inventors: Nancy A. Sullivan, Paramus, NJ (US); Nicholas Minicucci, JR., Allendale, NJ (US); Frank Holtham, JR., Saddle River, NJ (US); Donald R. Phillips, Arlington, TN (US)

(21) Appl. No.: 13/359,546

(22) Filed: Jan. 27, 2012

Related U.S. Application Data
(60) Provisional application No. 61/437,066, filed on Jan. 28, 2011.

(51) Int. Cl. B60R 16/00; H05B 1/02; H05B 3/02

(52) U.S. Cl. 219/202; 219/507; 219/494; 219/538

(57) ABSTRACT

An electrical apparatus for removing ice and snow from the exterior top surface of the roof of a vehicle comprises at least one electrical heating element disposed against, and in direct contact with, the interior bottom surface of the roof. The heating element may be installed by the vehicle manufacturer or may be retrofit, and in the case of an automobile having a roof liner, the heating element is disposed below and in contact with the roof, but above the liner. Current to the heating element may be controlled by the vehicle's rear window defogger switch, through a relay.

### CROSS-REFERENCE TO RELATED APPLICATION

This application claims the benefit of Provisional patent application 61/437,066, filed Jan. 28, 2011 under 35 USC §119(e)(1).

### BACKGROUND OF THE INVENTION

Accumulation of ice and snow on the roofs of vehicles poses a continued safety hazard to the driver and to other motorists. Left on the roof, the frozen precipitation can become dislodged by heat, vibration, or sudden acceleration or deceleration. The dislodged snow or ice can obstruct the driver's vision through the front or rear windshield, land on a road surface causing another vehicle to lose traction, disrupt the vision of another driver, damage another vehicle, or cause personal injury.

Although statistics on snow- or ice-related incidents are not readily available, it has become clear in recent years that accumulation of ice and snow on vehicle roofs is a sufficiently significant hazard to warrant legislative action. In response to the problem, certain states, including New Jersey, have enacted snow and ice removal legislation, requiring motorists to clear snow and ice from the entire exterior of their vehicle, including the roof. Exceptions have been made for commercial tractor trailer rigs traveling to snow-removal stations.

Ice and snow removal systems utilizing heat for clearing vehicle roofs have been described previously by others, but are neither widely available on new vehicles nor readily retrofitted. Known removal systems are also complex, and costly and increase vehicle weight significantly. Without such systems, motorists must spend considerable time clearing snow and ice from their vehicles manually, risking damage to exterior paint from removal tools, and risking personal injury in reaching onto the roofs of taller vehicles such as sport utility vehicles and pick-up trucks.

### SUMMARY OF THE INVENTION

The invention described herein addresses the need for an apparatus for removing ice and snow from the exterior top surface of the roof of a vehicle. At least one electrical heating element comprising a length of resistive electrical conductor is disposed against the interior bottom surface of the roof. The conductor is hidden by the interior liner, and may be secured to the underside of the roof by various means, preferably by strips of adhesive-coated tape or similar material. The heating element is connected to the vehicle's storage battery, preferably through a suitable current-limiting device such as a fuse or circuit breaker. In one embodiment, the heating element is activated and deactivated in synchronism with the operation of the vehicle's rear-window defogging element. The heating element can also be deactivated by a timer, or in response an external temperature sensor.

### BRIEF DESCRIPTION OF THE DRAWINGS

FIG. 1 is a schematic diagram of an embodiment of the invention;

FIG. 2 is a schematic bottom plan view of a portion of a vehicle roof equipped with a show and ice removal apparatus according to the invention with the headliner of the vehicle partially peeled away; and

FIG. 3 is a vertical section through a portion of the vehicle roof in FIG. 2.

### DETAILED DESCRIPTION OF THE INVENTION

The ice and snow removal apparatus according to the invention is constructed of commercially available materials, adds minimum weight to a vehicle, and does not materially increase the complexity to the vehicle assembly process. Further, the apparatus is easily repaired, can be retrofitted into existing vehicles, and poses no additional environmental risk upon disposal of a vehicle at the end of its useful life. The apparatus is also compatible with Hybrid Drive Technology vehicles. It can be run on battery power alone, or, in trucks, tractors, and semi-trailers, can be run on the vehicle battery and on APUs (Auxiliary Power Units).

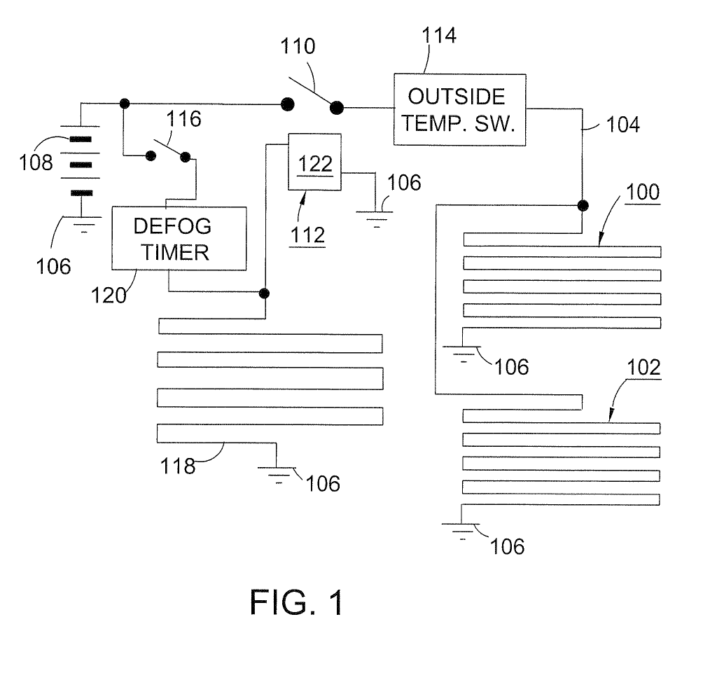

In the embodiment depicted in the circuit diagram of FIG. 1, the apparatus includes two electrical heating elements 100 and 102, each comprising a length of electrically conductor in the form of resistance wire or tape, preferably composed of a suitable material such as a nickel-chromium alloy (nichrome). The electrical conductor is preferably encased in a thin sheath of material such as PTFE or the like, which exhibits good electrical insulating properties, but is capable of conducting heat. The sheathed conductor of each heating element is preferably disposed in an undulating pattern so that it is composed of a series-connected plurality of conductor in spaced, side-by-side, relationship to one another. The two heating elements in FIG. 3 are connected electrically in parallel between a line 104 and the vehicle body, the latter being designated by “ground” symbols 106.

The parallel arrangement of heating elements is powered by the vehicle's storage battery 108 through normally open contacts 110 of relay 112, and, optionally, a temperature-responsive “outside temperature switch” 114, which automatically opens the circuit to the heating elements, thereby disabling them, when the outdoor temperature exceeds a predetermined level, which can be set at any suitable temperature level above the freezing point of water.

In the embodiment shown, the vehicle is equipped with a convention rear window defogger, and the operation of the snow and ice removal heating elements 100 and 102 is controlled in response to operation of the manual switch 116 that activates the vehicle's defogger. The relay 112 is used so that the heating elements 100 and 102 are connected to the battery through a circuit separate from circuit powering the rear window defogging element 118, allowing the defogging element and the snow and ice removal heaters to be protected by separate fuses (not shown). In many vehicles, the rear window defogging element is supplied with current through a timer such as timer 120, which disables the defogging element after a predetermined interval following closure of the defogging switch. In the apparatus in FIG. 1, the coil 122 of relay 112 is connected to the output terminal of the timer 120 so that the ice and snow removal heaters are deactivated at the end of the time interval established by timer 120 if not already deactivated by operation of the outside temperature switch 114. Alternatively, the relay coil can be connected to the input side of the defogging timer 120, thereby bypassing the timer. However, the connection to the output side of the timer, as shown, is preferred as the timer provides protection against excessive battery drainage.

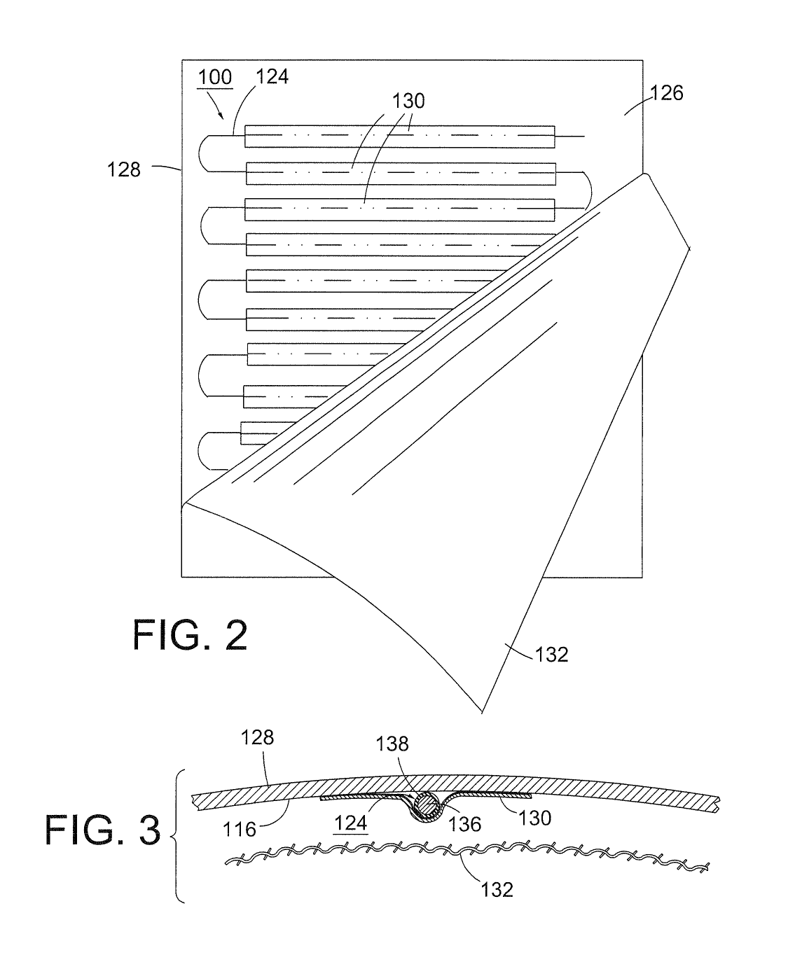

The heating elements are preferably in direct contact with the underside of the vehicle roof. As shown in FIG. 2, a heating element 100, in the form of an undulating cable 124, is secured to the underside 126 of a vehicle roof 128 by lengths 130 of tape, preferably adhesive-coated metal tape of the kind used to seal seams in heating ducts. When in use, the heating element is hidden from view by a roof liner 132, which is shown partly peeled away in FIG. 2. The heating element, or heating elements, can be readily retrofit to an automobile by temporarily detaching the roof liner, and arranging the cable in a suitable undulating pattern on the underside of the roof while securing the cable to the roof by lengths of metal adhesive tape. The undulating pattern preferably consists of a series-connected plurality of conductor elements in, spaced, side-by-side, relationship for applying heat, by thermal conduction, substantially uniformly to an area of the vehicle roof. Wiring connecting the heating elements to the relay 110 (FIG. 1) and to the outside temperature switch 114, if present, can be routed behind the roof liner 132 and through spaces (not shown) provided within the vehicle's roof supports. Following installation, the liner is returned to its original position, and the heating elements and wiring are hidden from view.

As shown in FIG. 3, the cable 124 consists of an electrically conductive core 136, composed of an electrically resistive material such as a nickel-chromium alloy, within a sheath 138 composed of an electrical insulating but heat-conducting material such as PTFE. The sheath 138 is in direct contact with the underside 126 of the vehicle roof 128, and held in contact with the underside of the roof by tape 130.

The ice and snow removal apparatus according to the invention will be most useful in preparing a vehicle for travel when it has been parked outside during a snow storm or in weather such that precipitation has had an opportunity to form a layer of ice on the vehicle roof. In the case of a deep snow accumulation, some preliminary manual snow removal may be desirable. Initially, or following preliminary manual snow removal, the driver can activate the heating element, or heating elements, by closing the vehicle's defogging switch 116 (FIG. 1). Closure of the defogging switch not only activates the rear window defogging element 118, but also closes relay contacts 110, which route current from the vehicle's storage battery 108 to the roof heating elements 100 and 102 through the outside temperature switch 114.

The resistance of the heating elements is determined by the composition of the conductor 136, its diameter, and its length. Preferably, these parameters are preferably selected so that the temperature of the roof is raised to a temperature not more about 49° C. (120° F.) when the roof is at 0° C. (32° F.) as a result of ice or snow accumulation. If the temperature of the roof is limited to about 49° C., damage to the vehicle's exterior paint can be avoided. At a temperature between 16° C. (60° F.) and 49° C. (120° F.), the bottom of the ice or snow layer on the vehicle roof is melted rapidly, and the layer can be removed readily, either by brushing, or through inertia when the vehicle starts moving, before it gets into traffic. When the ice or snow layer is removed, the defogger switch 116 can be opened, shutting off current to the relay coil 122 and deactivating the heating elements 100 and 102.

For a conventional sedan, 8 amperes of current, dissipating about 100 watts is sufficient to detach an ice or snow layer within a few minutes. Thus, the lengths, diameters and materials of the heating elements may be selected to present a resistance of about 1.5Ω between line 104 and the vehicle ground 106.

Although a specific embodiment has been described, many modifications can be made. For example, especially in a new vehicle, the circuit to which the roof heating elements are connected can be independent of the defogging switch, and a separate switch can be provided. The separate switch can be associated with a shut-off timer for automatically deactivating the heating elements after a predetermined time interval in order to avoid excessive battery drain.

The defogger control, or in the case of a defogger-independent dedicated roof heating control, the manually operated switch, can be a momentary switch associated with a holding relay, or with an electronic equivalent of a holding relay, that opens automatically in response to a timer, thereby obviating the step of opening the switch manually. Such devices are commonly used in vehicle window defogging circuits.

The outside temperature switch 114 includes a sensor at a location such that it senses the temperature of the air outside the vehicle and a sensor-responsive switch for cutting off current in line 104 when the outside temperature exceeds a predetermined value. This predetermined value should correspond to an atmospheric temperature at which the bottom of a layer of ice or snow on the vehicle roof will not remain attached to the roof for more than several minutes, e.g., 10° C. (50° F.).

The roof can be heated by a single heating element, or by plural heating elements connected electrically in parallel. The arrangement and number of heating elements will depend to a large extent on the roof area to be heated, and the resistivity of the electrical conductor.

The conductor in the heating elements may be composed of any of a large number of suitable resistive materials. Preferably, the material is a nickel-chromium alloy, e.g., one composed of 80% nickel and 20% chromium, by weight. Other known resistive materials include iron-chromium-aluminum (FeCrAl) alloys and copper-nickel (CuNi) alloys. Flexible non-metallic resistive compositions can also be used. The conductor may be composed of round, single-strand wire, multiple strand wire, flat ribbon or other forms of conductor.

Although in the case of a vehicle using an internal combustion engine, the power source will ordinarily be the same 12 volt storage battery that is used to supply power to the engine starter and other electric power consuming vehicle components, other power sources can be used. For example, in a hybrid vehicle or an electric-powered vehicle, current for operating the heating elements can be derived from a battery or fuel cell used to provide propulsive power. Especially in the case of a larger vehicle such as a truck or trailer, electric power for the heating elements can be supplied by an auxiliary generator.

The heating elements may be secured to the interior surface 126 of the roof by means other than adhesive-coated metal tape, for example by adhesive material incorporated into the insulation of the heating elements and temporarily covered by a removable protective strip that is peeled away immediately prior to installation of the heating elements. Other connecting devices such as magnets can be used.

The space between the underside of the vehicle roof and the liner can be an air space, or can be partially or completely filled with an insulating such as glass fiber insulation. In some applications, such as in cargo compartments of trucks and trailers, where esthetic appearance is unimportant, the roof liner can be eliminated altogether, and in such a case, because the liner does not need to be reattached to the vehicle roof, installation of the heating elements is simpler and less expensive.

Many other modifications can be made to the apparatus described herein without departing from the scope of the invention as defined by the following claims.

What is claimed is:

1. In a vehicle having a rigid roof, the roof having an exterior top surface on which snow and ice can accumulate and an interior bottom surface, apparatus for removing ice and snow from the exterior top surface of the roof, the apparatus comprising:
at least one electrical heating element comprising a length of resistive electrical conductor, the heating element being disposed against the interior bottom surface of the roof;
means for securing said at least one electrical heating element to the interior bottom surface of the roof whereby said heating element is maintained in contact with said bottom surface of the roof; and
an electrical circuit connecting the heating element to an electric power supply, said circuit including a set of switch contacts for conducting current from the electric power supply to the heating element when the switch contacts are closed and for shutting off current to the heating element when the switch contacts are open.

2. The apparatus according to claim 1, in which the conductor of the heating element is composed of a series-connected plurality of conductor elements in spaced, side-by-side relationship for applying heat by thermal conduction to an area of said roof.

3. In a vehicle having a rigid roof overlying a passenger compartment, the roof having an exterior top surface on which snow and ice can accumulate and an interior bottom surface, and a liner underneath said roof and spaced therefrom, the liner forming a ceiling of the passenger compartment, apparatus for removing ice and snow from the exterior top surface of the roof, the apparatus comprising:
at least one electrical heating element comprising a length of resistive electrical conductor, the heating element being disposed against the interior bottom surface of the roof in an undulating pattern whereby the conductor of the heating element is composed of a series-connected plurality of conductor elements in, spaced, side-by-side relationship for applying heat by thermal conduction to an area of said roof;
means for securing said at least one electrical heating element to the interior bottom surface of the roof whereby said heating element is in contact with said bottom surface of the roof; and
an electrical circuit connecting the heating element to a storage battery of the vehicle, said circuit including a set of switch contacts for conducting current from the battery to the heating element when the switch contacts are closed and for shutting off current to the heating element when the switch contacts are open;
said at least one electrical heating element being disposed between said roof and said liner.

4. The apparatus according to claim 3, in which said switch contacts are contacts of a relay having an electromagnetic coil for closing said contacts, the coil being connected electrically to a rear-window defogging element, and being activated to close said contacts when the rear-window defogging element is activated.

5. The apparatus according to claim 4, wherein said circuit further comprises a timer for shutting off current to said at least one electrical heating element following a predetermined time interval, wherein the relay coil is connected to an output of said timer.

6. The apparatus according to claim 3, wherein said circuit further comprises an outside temperature sensor, wherein the sensor opens a switch shutting off current to said at least one electrical heating element when the outside temperature exceeds a predetermined value exceeding the freezing point of water.

7. The apparatus according to claim 3, comprising more than one electrical heating element, wherein the electrical heating elements are electrically connected in parallel.

8. The apparatus according to claim 3, wherein the resistance of said at least one electrical heating element is such that the maximum temperature of the roof is not more than approximately 49 degrees Celsius when the heating element is in contact with the interior bottom surface of the roof and connected to a 12 volt power source.

9. The apparatus according to claim 3, wherein said at least one electrical heating element comprises a nickel-chromium alloy.

10. The apparatus according to claim 3, wherein said alloy is 80% nickel and 20% chromium.

11. The apparatus according to claim 3, wherein said at least one electrical heating element is secured to the interior bottom surface of the roof with strips of adhesive-coated material.

12. The apparatus according to claim 3, wherein said at least one electrical heating element is secured to the interior bottom surface of the roof with strips of adhesive-coated metal.

13. In a vehicle having a rigid roof overlying a passenger compartment, the roof having an exterior top surface on which snow and ice can accumulate and an interior bottom surface, and a liner underneath said roof and spaced therefrom, the liner forming a ceiling of the passenger compartment, apparatus for removing ice and snow from the exterior top surface of the roof, the apparatus comprising:
at least one electrical heating element comprising a length of resistive electrical conductor, the heating element being disposed against the interior bottom surface of the roof in an undulating pattern whereby the conductor is composed of a series-connected plurality of conductor elements in, spaced, side-by-side relationship for applying heat by thermal conduction to an area of said roof;
strips of adhesive-coated material securing said at least one electrical heating element to the interior bottom surface of the roof; and
an electrical circuit connecting the heating element to a storage battery of the vehicle, said circuit including a set of switch contacts for conducting current from the battery to the heating element when the switch contacts are closed and for shutting off current to the heating element when the switch contacts are open;
said at least one electrical heating element being disposed between said roof and said liner.
